(19) United States
(12) Patent Application Publication
(10) Pub. No.: US 2025/0292272 A1
(43) Pub. Date: Sep. 18, 2025

(54) DATA PROCESSING AND VISUALIZATION METHOD, MEDIUM AND DEVICE

(71) Applicant: Ndival Technology (Zhuhai) Co., Ltd, Zhuhai (CN)

(72) Inventors: Qi HE, Zhuhai (CN); Zhengheng XIE, Zhuhai (CN); Zhiyi ZHAO, Zhuhai (CN); Yichen HE, Zhuhai (CN); Guiduo FU, Zhuhai (CN)

(21) Appl. No.: 19/227,135

(22) Filed: Jun. 3, 2025

Related U.S. Application Data
(63) Continuation of application No. PCT/CN2024/076239, filed on Feb. 6, 2024.

(30) Foreign Application Priority Data
Dec. 12, 2022 (CN) 202211597220.8

(51) Int. Cl. G06Q 30/0202; G06F 7/08; G06Q 30/0201; G06T 11/00; G06T 11/20

(52) U.S. Cl. CPC G06Q 30/0202; G06F 7/08; G06Q 30/0206; G06T 11/001; G06T 11/206; G06T 2200/24

(57) ABSTRACT

The present disclosure relates to the technical field of big data and artificial intelligence. Disclosed are a data processing and visualization method, medium and device. The method includes: selecting a data platform to acquire source data of a target enterprise, sorting the source data and loading the source data into a data system to serve as a source database table, executing a primary data operation to process the source data into target data, executing a secondary data operation to process the target data into value-added data, executing a tertiary data operation to process relevant data into graphic data, and executing data visualization, so as to draw and render a visual graph by using the graphic data.

### TECHNICAL FIELD

The present disclosure relates to the technical field of big data and artificial intelligence, and in particular, to a data processing and visualization method, medium and device.

### BACKGROUND

With the development of new generation information technology, more and more data information resources have been generated, providing better support for the development of enterprises in various industries. In the field of modern enterprise management research, listed enterprises are generally selected as research objects, and the operating conditions and market performance of target enterprises are taken as benchmarks for enterprise management and relevant plans are formulated based on the benchmarks.

At present, in terms of corresponding business data and market data, in the existing technologies, selected data are mainly processed according to their respective uses and combined with commonly used data visualization methods. In the process of implementing the present disclosure, it is found that the existing technologies still have many problems in the acquisition, sorting, processing and visualization of relevant data of target enterprises that: source data cannot be acquired timely and completely; there is a serious lag in relevant indicator data; there are still discrepancies in some of the published indicator data; some of the relevant data need to be updated dynamically, which also affects the efficiency of data processing; there is a lack of more effective methods for analyzing capacity of relevant enterprises, leading to low analysis accuracy; and there is a lack of intuitive and clear data display methods for the operating conditions and market performance of the target enterprises being studied.

Therefore, how to improve the timeliness and completeness of source data acquisition, improve the efficiency of data processing, improve the accuracy of analysis of data of a target enterprise, improve the effectiveness of data display and improve the availability of a data system are a series of problems that need to be addressed urgently.

### SUMMARY

The present disclosure provides a data processing and visualization method, medium and device, to at least partially solve the technical problems about how to improve the timeliness and completeness of source data acquisition, improve the efficiency of data processing, improve the accuracy of analysis of data of a target enterprise, improve the effectiveness of data display and improve the availability of a data system.

To address the above problems, the present disclosure uses the following technical solutions.

A data processing and visualization method includes:
acquiring source data of a target enterprise from a data platform, storing the source data in a preset data system, and sorting the source data stored in the preset data system as target data;
creating a data model and algorithm, forecasting a net profit growth rate of the target enterprise according to the target data, determining a corresponding net profit after deducting non-recurring gains and losses of the target enterprise as a recurring profit, determining a capacity indicator of the target enterprise according to the recurring profit, and determining a value space of the target enterprise according to the capacity indicator and the net profit growth rate, to determine a fitting range and a corresponding value score of value capacity of the target enterprise according to the value space, and then determine a score of each dimension of comprehensive capacity of the target enterprise;
drawing and rendering a corresponding visual graph according to a background data relationship in the data model and algorithm in conjunction with the target data, the value space, the value capacity, the value score and the comprehensive capacity, specifically including:
   selecting graphic data, and coupling background data and a front-end display of a panel interface using visualization tool software in conjunction with self-compiled programs for completing automation tasks; and
   drawing and rendering a corresponding visual graph according to a background data relationship in the data model and algorithm, where the visual graph includes: an industry map, a concept map, a comprehensive capacity map, a value capacity map, a growth capacity map, a revenue growth map, a profit growth map, an enterprise N-dimensional map and a panel interface map;
where the target data platform includes a plurality of different data platforms, and acquiring source data of a target enterprise from the data platform specifically includes:
   acquiring source data of the target enterprise corresponding to each of a plurality of preset time points from each of the data platforms, including: acquiring the source data by means of a segmentation method according to data attributes and scroll refresh time; and determining each data belonging to associated data in a report form according to a format of the report form, and acquiring the source data from the respective target data platform according to a computer-written segmentation acquisition condition to achieve respective acquisition of all associated data;
   determining missing data of the source data acquired at the latest time point, to search for the missing data from the source data obtained at other time points and fill the missing data into the source data acquired at the latest time point, and storing the source data in a preset data system as source data to be processed;
   sorting the source data to be processed as target data; and
where sorting the source data stored in the preset data system includes:
   executing a primary data operation to output the source data to a primary database table;
   executing a secondary data operation and outputting a primary database table, using relevant data to create an integrated multi-dimensional data model and algorithm, and conducting an integration analysis on the target enterprise; and
   executing a tertiary data operation to process relevant data in the primary database table and the secondary database table into corresponding graph database tables; and where drawing and rendering the corresponding visual graph includes:
   determining rendering colors of all industry maps and all concept maps according to subordinate relationships and association relationships between the industry maps and the concept maps, to represent categories and hierarchical relationships of the industry maps and the concept maps through the rendering colors,
   where the industry maps are divided according to an industry to which the target enterprise belongs, and the industry maps are divided into at least three grades according to the subordinate relationships of the industry maps; the concept maps are divided according to a concept to which the target enterprise belongs, and the concept maps are divided into at least three grades according to the association relationships and/or the subordinate relationships of the concept maps; and
   displaying the graded rendering colors of the industry maps and the concept maps in an association manner through the panel interface, and displaying the concept maps in a scrolling manner; and
   automatically combining visual graphs corresponding to the target data, the value space, the value capacity, the value score and the comprehensive capacity are together for display to
obtain the enterprise N-dimensional map which is configured to represent an overall outline of
operating condition and market performance of the target enterprise.

Optionally, creating the data model and algorithm, to determine the fitting range and the corresponding value score of value capacity of the target enterprise according to the value space, and then determine the score of each dimension of comprehensive capacity of the target enterprise specifically includes:
determining a value capacity indicator, a growth capacity indicator, a revenue growth indicator and a profit growth indicator corresponding to the target enterprise according to the target data,
where the value capacity indicator includes a fitting range and a corresponding value score of value capacity of the target enterprise; and
determining the value score for characterizing the comprehensive capacity of the target enterprise through segment scoring and dimension comparison according to the four basic dimensions including the value capacity indicator, the growth capacity indicator, the revenue growth indicator and the profit growth indicator.

Optionally, determining the fitting range and the corresponding value score of value capacity of the target enterprise according to the value space specifically includes:
determining the fitting range of value capacity according to an upper limit and a lower limit of the value space, and comparing value scores of the upper limit and the lower limit of the value space and determining the corresponding value score of the value capacity as a smaller one of the value scores of the upper limit and the lower limit of the value space.

Optionally, determining the value space of the target enterprise specifically includes:
forecasting the net profit growth rate of the target enterprise according to the target data, the net profit growth rate including: a first net profit growth rate, a second net profit growth rate and a third net profit growth rate, where the first net profit growth rate is a net profit growth rate for the next first year, the second net profit growth rate is a net profit growth rate for the next second year, and the third net profit growth rate is an average net profit growth rate for the next two years; and
determining the capacity indicator of the target enterprise according to the recurring profit, the capacity indicator including: a first capacity indicator, a second capacity indicator, a third capacity indicator and a fourth capacity indicator, where the first capacity indicator is a ratio of a market value of the target enterprise to an annualized recurring profit involved in a quarterly report form of a current quarter, the second capacity indicator is a ratio of the market value to a recurring profit involved in an annual report form of a current year, the third capacity indicator is a ratio of the market value to a recurring profit of the target enterprise in the next year, and the fourth capacity indicator is a ratio of
the market value to a forecasted annualized recurring profit involved in a next quarterly report form; and
where determining the value space of the target enterprise according to the capacity indicator and the net profit growth rate includes:
determining a first group of value indicators according to the first net profit growth rate, the third net profit growth rate and the first capacity indicator;
determining a second group of value indicators according to the first net profit growth rate, the third net profit growth rate and the second capacity indicator;
determining a third group of value indicators according to the second net profit growth rate, the third net profit growth rate and the third capacity indicator;

determining a fourth group of value indicators according to the first net profit growth rate, the third net profit growth rate and the fourth capacity indicator;
determining the upper limit of the value space according to the first group of value indicators, the second group of value indicators and the third group of value indicators; and
determining the lower limit of the value space according to the first group of value indicators, the second group of value indicators, the third group of value indicators and the fourth group of value indicators.

Optionally, determining the value space of the target enterprise further includes:
determining growth price-to-earnings times as a GPET indicator according to the net profit growth rate and a dynamic price-to-earnings ratio after deducting non-recurring gains and losses of the target enterprise, where the GPET indicator is a single-segment value indicator and/or a segmented composite integrated value indicator;
in response to the GPET indicator being the integrated value indicator, determining the GPET indicator by comparing a segmented and/or composite net profit growth rate with a moving dynamic price-to-earnings ratio after deducting non-recurring gains and losses in conjunction with a method for interactive comparison of values; and
determining the value space according to the GPET indicator.

Optionally, after determining the value space of the target enterprise, the method further includes:
acquiring goodwill data corresponding to a goodwill-to-assets ratio of the target enterprise from the data platform; and
amending the value space according to the goodwill data.

Optionally, determining the score of each dimension of comprehensive capacity of the target enterprise further comprises:
determining a growth rate forecast indicator of the target enterprise according to a forecasted earnings per share growth rate contained in the target data, and re-determining the growth rate forecast indicator after the target data is updated, to determine a changing trend of growth of the target enterprise according to a changing trend of the growth rate forecast indicator, and determine a dimension score of a growth capacity of the comprehensive capacity of the target enterprise.

Optionally, after determining the score of each dimension of comprehensive capacity of the target enterprise, the method further includes:
re-acquiring the source data of the target enterprise at preset time intervals; and
determining a range of change between year-by-year forecast data of operating earnings, net profit and earnings per share of the target enterprise contained in the updated target data and year-by-year forecast data of operating earnings, net profit and earnings per share of the target enterprise contained in the unupdated target data using the latest acquired target data in response to a refresh operation on the target data, to determine an amendment range according to the range of change.

Optionally, after determining the score of each dimension of comprehensive capacity of the target enterprise, the method further includes:
determining a comprehensive target price of the target enterprise according to the target data, and determining a target space of the target enterprise according to the comprehensive target price and the current price, to maintain amendment coverage by regularly updating the comprehensive target price.

A data processing and visualization medium, that is, a computer-readable storage medium stores a computer program which, when executed by a processor, causes the processor to implement any one of the above-described methods.

An electronic device includes a memory, a processor and a computer program stored in the memory and executable on the processor, where the processor implements the above-described method when executing the program.

The at least one technical solution used in the present disclosure may achieve the following beneficial effects:

A data processing and visualization method provided in the present disclosure includes: first, acquiring source data of a target enterprise from a data platform, storing the source data in a preset data system, and sorting the source data stored in the preset data system as target data; then, creating a data model and algorithm, forecasting a net profit growth rate of the target enterprise according to the target data, determining a corresponding net profit after deducting non-recurring gains and losses of the target enterprise as a recurring profit, determining a capacity indicator of the target enterprise according to the recurring profit, and determining a value space of the target enterprise according to the capacity indicator and the net profit growth rate, to determine a fitting range and a corresponding value score of value capacity of the target enterprise according to the value space, and then determine a score of each dimension of comprehensive capacity of the target enterprise; finally, drawing and rendering a corresponding visual graph according to a background data relationship in the data model and algorithm in conjunction with the target data, the value space, the value capacity, the value score and the comprehensive capacity.

It can be seen from the above method that different data platforms may be selected, and timely and complete acquisition of source data can be ensured by acquiring data at different time points and acquiring data in segments. The acquired source data may be sorted according to data attributes and data scripts to ensure that the source data is available. An integrated multi-dimensional data model and algorithm is created, and new indicators are established to strengthen the rigor of a data model definition, especially the determination by comparing the forecasted net profit growth rate with the dynamic price-to-earnings ratio after deducting non-recurring gains and losses. Deducting non-recurring gains and losses reduces the impact of factors other than the normal operation of the enterprise on analysis, the segment determination in conjunction with moving benchmarks and the adoption of the method for interactive comparison of values reduce determination deviations. The added forecast data determination improves timeliness, and the value amendment factor determination reduces risks, so that the data model and algorithm of the present disclosure can systematically improve the accuracy of analysis of the comprehensive capacity of the enterprise. Background data and a front-end display of a panel interface may be coupled using visualization tool software in conjunction with self-compiled programs for completing automation tasks, thereby improving the effectiveness of data display, and also improving the availability of a data system.

### BRIEF DESCRIPTION OF DRAWINGS

The accompanying drawings described here are provided for a further understanding of the present disclosure, and constitute a part of the present disclosure. The illustrative embodiments of the present disclosure and their descriptions are used to explain the present disclosure and do not constitute improper limitations on the present disclosure. In the accompanying drawings:

FIG. 1 is a schematic flowchart of a data processing and visualization method provided in the present disclosure;

FIG. 2 is a schematic diagram of an embodiment of a data processing and visualization method provided in the present disclosure;

FIG. 3 is a schematic flowchart of a software medium implementation provided in the present disclosure; and

FIG. 4 is a schematic diagram of an electronic device corresponding to FIG. 1 provided in the present disclosure.

### DETAILED DESCRIPTION

In order to make the objectives, technical solutions and advantages of the present disclosure more clear, the technical solutions of the present disclosure will be clearly and completely described below in conjunction with the specific embodiments of the present disclosure and the corresponding drawings. Obviously, the described embodiments are only some rather than all of the embodiments of the present disclosure. All other embodiments obtained by those of ordinary skill in the art based on the embodiments in the present disclosure without making any creative work shall fall within the scope of protection of the present disclosure.

It can be seen from the above description that the data processing and visualization method provided in the present disclosure involves the following core innovation points: source data is acquired by means of a segmentation method according to relevant data attributes and scroll refresh time; an integrated multi-dimensional data model and algorithm is created, and new indicators are established to strengthen the rigor of a data model definition, especially the determination by comparing the forecasted net profit growth rate with the dynamic price-to-earnings ratio after deducting non-recurring gains and losses, the segment determination in conjunction with moving benchmarks, the adoption of the method for interactive comparison of values, the added forecast data determination and the value amendment factor determination; background data and a front-end display of a panel interface are coupled using visualization tool software in conjunction with self-developed programs for completing automation tasks, and a visual graph is drawn and displayed according to a background data relationship in the data model and algorithm; and artificial intelligence rendering using machine learning and model training based on a map mode is performed, and artificial intelligence data simulation, forecast and analysis using machine learning and model training based on a data model and algorithm are performed. In the present disclosure, the execution subject for the specific implementation of the data processing method may be a desktop computer, a laptop, a mobile phone, or other terminal device used by an operator. For the sake of ease of description below, only the terminal device is used as the execution subject of the data processing method provided in the present disclosure.

At present, the existing technologies still have many problems in the acquisition, sorting, processing and visualization of relevant data of target enterprises that: source data cannot be acquired timely and completely; there is a serious lag in relevant indicator data; there are still discrepancies in some of the published indicator data; some of the relevant data need to be updated dynamically, which also affects the efficiency of data processing; there is a lack of more effective methods for analyzing capacity of relevant enterprises, leading to low analysis accuracy; and there is a lack of intuitive and clear data presentation methods for the operating conditions and market performance of the target enterprises being studied.

Based on this, the present disclosure provides a data processing and visualization method to at least partially solve the above-mentioned problems.

The technical solutions provided by various embodiments of the present disclosure are described in detail below in conjunction with the accompanying drawings.

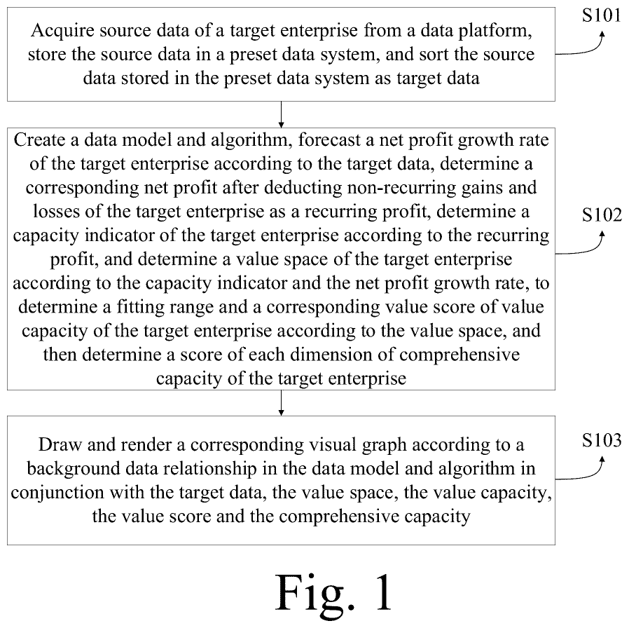

FIG. 1 is a schematic flowchart of a data processing and visualization method provided in the present disclosure, the method including the following steps.

At S101, source data of a target enterprise is acquired from a target data platform, the source data is stored in a preset data system, and the source data stored in the preset data system is sorted as target data.

Specifically, a terminal device may acquire source data of the target enterprise corresponding to each of a plurality of preset time points from each of a plurality of different data platforms; determine missing data of the source data acquired at the latest time point, to search for the missing data from the source data acquired at other time points and fill the missing data into the source data acquired at the latest time point, and store the source data in a preset data system as source data to be processed; and sort the source data to be processed as target data.

The terminal device may acquire source data of the target enterprise corresponding to each of a plurality of preset time points from each of the data platforms according to a computer-written segmentation acquisition condition.

It should be noted that, in practical applications, the data to be processed may be divided into associated data and unassociated data, where the associated data can only be acquired after other data are determined, for example, if garment factory A does not acquire today's clothing material expense, today's net profit data cannot be determined.

Therefore, for associated data, if the associated data in the data to be processed is acquired as a whole, the missing of some associated data may lead to the missing of other associated data, resulting in a situation where less data is acquired. In the present disclosure, the terminal device may acquire the format of a report form of the target enterprise, to determine various data belonging to the associated data in the report form according to the format of the report form, and respectively capture various associated data to acquire various source data. In practical applications, the terminal device may acquire the source data from the target data platform according to a computer-written condition to acquire the various associated data respectively.

At S102, a data model and algorithm is created, a net profit growth rate of the target enterprise is forecasted according to the target data, a corresponding net profit of the target enterprise after deducting non-recurring gains and losses is determined as a recurrent profit, a capacity indicator of the target enterprise is determined according to the recurrent profit, and a value space of the target enterprise is determined according to the capacity indicator and the net profit growth rate, to determine a fitting range and a corresponding value score of value capacity of the target enterprise according to the value space, and then determine a score of each dimension of comprehensive capacity of the target enterprise.

After acquiring the target data, the terminal device may forecast the net profit growth rate of the target enterprise according to the target data. Specifically, the terminal device may forecast the net profit growth rate of the target enterprise using a pre-trained net profit growth rate forecast model, or may directly use the net profit growth rate forecasted by the target enterprise itself contained in the target data.

In practical applications, there may be some non-periodic extra income, resulting in the inaccuracy of the net profit data in the target data. For example, garment factory A sold a factory building in this quarter, and the income was included in the net profit of this quarter, greatly increasing the net profit of garment factory A in this quarter. However, this increase in net profit cannot characterize the operation and management capacity of garment factory A. Therefore, in order to improve the accuracy of analyzing the operation capacity of the target enterprise, in the present disclosure, the corresponding net profit after deducting non-recurring gains and losses of the target enterprise may be determined as a recurring profit according to the target data.

In the present disclosure, in order to more accurately characterize the operation and management capacity of the target enterprise, a ratio of a market value of the target enterprise to a recurring profit may be taken as a capacity indicator of the target enterprise, to determine a subsequent value space according to the capacity indicator of the target enterprise.

After acquiring the net profit growth rate and the recurring profit of the target enterprise, the terminal device may determine a value space of the target enterprise, where the value space is an indicator that characterizes the operation and management capacity of the target enterprise.

Specifically, the terminal device may forecast a net profit growth rate of the target enterprise according to the target data, the net profit growth rate including: a first net profit growth rate, a second net profit growth rate and a third net profit growth rate, where the first net profit growth rate is a net profit growth rate for the next first year, the second net profit growth rate is a net profit growth rate for the next second year, and the third net profit growth rate is an average net profit growth rate for the next two years; determine a capacity indicator of the target enterprise according to the recurring profit, the capacity indicator including: a first capacity indicator, a second capacity indicator, a third capacity indicator and a fourth capacity indicator, where the first capacity indicator is a ratio of a market value of the target enterprise to an annualized recurring profit involved in a quarterly report form of the current quarter, the second capacity indicator is a ratio of the market value to a recurring profit involved in an annual report form of the current year, the third capacity indicator is a ratio of the market value to a recurring profit of the target enterprise in the next year, and the fourth capacity indicator is a ratio of the market value to a forecasted annualized recurring profit involved in the next quarterly report form. Thereafter, the terminal device may determine the value space of the target enterprise according to the capacity indicator and the net profit growth rate, including: determine a first group of value indicators according to the first net profit growth rate, the third net profit growth rate and the first capacity indicator; determine a second group of value indicators according to the first net profit growth rate, the third net profit growth rate and the second capacity indicator; determine a third group of value indicators according to the second net profit growth rate, the third net profit growth rate and the third capacity indicator; determine a fourth group of value indicators according to the first net profit growth rate, the third net profit growth rate and the fourth capacity indicator; determine the upper limit of the value space according to the first group of value indicators, the second group of value indicators, and the third group of value indicators; and determine the lower limit of the value space according to the first group of value indicators, the second group of value indicators, the third group of value indicators and the fourth group of value indicators.

Determining, by the terminal device, the value space of the target enterprise may further be implemented as follows. The terminal device may determine growth price-to-earnings times as a GPET indicator according to the net profit growth rate and the dynamic price-to-earnings ratio after deducting non-recurring gains and losses of the target enterprise, where the GPET indicator is a single-segment value indicator and/or a segmented composite integrated value indicator, and if the GPET indicator is the integrated value indicator, determine the GPET indicator by comparing a segmented and/or composite net profit growth rate with a moving dynamic price-to-earnings ratio after deducting non-recurring gains and losses in conjunction with a method for interactive comparison of values; and determine the value space according to the GPET indicator.

In addition, after determining the value space of the target enterprise, the terminal device may acquire goodwill data corresponding to a goodwill-to-assets ratio of the target enterprise from the target platform; and amend the value space according to the goodwill data.

The terminal device may determine the fitting range of the value capacity according to an upper limit and a lower limit of the value space, and compare value scores of the upper limit and the lower limit of the value space and determine the corresponding value score of the value capacity as a smaller one of the value scores of the upper limit and the lower limit of the value space. It should be noted that, influenced by the current market environment, the target enterprise is often unable to reach the upper limit of the value space. Meanwhile, in order to make a conservative estimate, the lower limit of the value space is often taken as a corresponding value score of the value space.

The terminal device may determine a value capacity indicator, a growth capacity indicator, a revenue growth indicator and a profit growth indicator corresponding to the target enterprise according to the target data, where the value capacity indicator includes a fitting range and a corresponding value score of value capacity of the target enterprise; and the terminal device may determine the value score for characterizing the comprehensive capacity of the target enterprise according to the four basic dimensions including the value capacity indicator, the growth capacity indicator, the revenue growth indicator and the profit growth indicator through segment scoring and dimension comparison.

Determining, by the terminal device, the score of each dimension of comprehensive capacity of the target enterprise may be implemented as follows. The terminal device may determine a growth rate forecast indicator of the target enterprise according to a forecasted earnings per share growth rate contained in the target data, and re-determine the growth rate forecast indicator after the target data is updated, to determine a changing trend of growth of the target enterprise according to a changing trend of the growth rate forecast indicator, and determine a dimension score of the growth capacity of the comprehensive capacity of the target enterprise.

It should be noted that, in order to ensure the validity of the data, after determining the score of each dimension of comprehensive capacity of the target enterprise, the terminal device may also re-acquire the source data of the target enterprise at preset time intervals; and determine a range of change between year-by-year forecast data of the operating earnings, net profit and earnings per share of the target enterprise contained in the updated target data and year-by-year forecast data of the operating earnings, net profit and earnings per share of the target enterprise contained in the unupdated target data using the latest acquired target data in response to a refresh operation on the target data, to determine an amendment range according to the range of change.

After determining the score of each dimension of comprehensive capacity of the target enterprise, the terminal device may also determine a comprehensive target price of the target enterprise according to the target data, and determine a target space of the target enterprise according to the comprehensive target price and the current price, to maintain amendment coverage by regularly updating the comprehensive target price.

At S103, a corresponding visual graph is drawn and rendered according to a background data relationship in the data model and algorithm in conjunction with the target data, the value space, the value capacity, the value score and the comprehensive capacity.

The terminal device may select graphic data, and couple background data and a front-end display of a panel interface using visualization tool software in conjunction with self-compiled programs for completing automation tasks; and draw and render a corresponding visual graph according to a background data relationship in the data model and algorithm, where the visual graph includes: an industry map, a concept map, a comprehensive capacity map, a value capacity map, a growth capacity map, a revenue growth map, a profit growth map, an enterprise N-dimensional map and a panel interface map.

The terminal device may determine rendering colors of all industry maps and all concept maps according to subordinate relationships and association relationships between the industry maps and the concept maps, to represent categories and hierarchical relationships of the industry maps and the concept maps through the rendering colors. The industry maps are divided according to an industry to which the target enterprise belongs, and the industry maps are divided into at least three grades according to the subordinate relationships of the industry maps. The concept maps are divided according to a concept to which the target enterprise belongs, and the concept maps are divided into at least three grades according to the association and/or subordinate relationships of the concept maps.

The present disclosure provides a data processing and visualization method, including: selecting a data platform to acquire source data of a target enterprise; sorting the source data and loading the source data into a data system to serve as a source database table; executing a primary data operation to process the source data into target data; executing a secondary data operation to process the target data into value-added data; executing a tertiary data operation to process relevant data into graphic data; and executing data visualization to draw and render a visual graph according to the graphic data.

An integrated multi-dimensional data model and algorithm is created, to conduct an integration analysis on the target enterprise, and new indicators are established, mainly including:

Growth price-to-earnings times GPET. GPET is a dynamic indicator, which may be used as a single-segment value indicator or as a segmented composite integrated value indicator, and determined by a net profit growth rate and a dynamic price-to-earnings ratio after deducting non-recurring gains and losses;

Dynamic price-to-earnings ratio after deducting non-recurring gains and losses PEAN. PEAN is a dynamic indicator, which is determined by the market value and the annualized recurring profit, and also represents the capacity indicator of the target enterprise when determining the value space in the data model;

Comprehensive capacity, including four basic dimensions of value capacity, growth capacity, revenue growth and profit growth, and a comparative dimension. Scoring criteria are set for reviewing the comprehensive capacity on an annual basis using a scoring method of segment comparison, which is achieved specifically through expert seminars. The comprehensive capacity is a comprehensive reflection of the capacity of the target enterprise in the four basic dimensions and the comparative dimension;

Value capacity. According to value scores corresponding an upper limit and a lower limit of a value space determination result, the smaller value score is taken as the value score of the value capacity. The value capacity is reflected as the capacity of the target enterprise to achieve a value fitting range when achieving a value fluctuation target;

Value space. The value space is determining by comparing the forecasted net profit growth rate with the dynamic price-to-earnings ratio after deducting non-recurring gains and losses. Specifically, corresponding values are determined by using the compound growth rate of the next two full years and the segmented growth rate respectively, then the corresponding values are determined in conjunction with moving benchmarks including the current quarter, the current year, the forecast quarter and the future year respectively, and finally, values are taken in conjunction with the method for interactive comparison, and preferentially data with a lower determined value are taken as a constraint condition in the value-taking process. Forecast data of enterprises that have issued performance forecasts are also determined. Moreover, the goodwill-to-assets ratio is approximately taken as a risk factor for the realization of enterprise value, and then a relevant determination is taken as an amendment factor for the value space of the enterprise, the value space being reflected as a possible growth range of the value of the target enterprise;

Target space. The comprehensive target price of a master data table in the target data is captured, which is used to determine a more intuitive target space of the current price relative to the comprehensive target price, and represented by the percentage of the determination result;

Growth capacity. The forecasted earnings per share growth rate are used to derive a growth rate forecast to represent future growth capacity, and a growth forecast amendment is used to dynamically track an adjustment trend of the growth forecast of the target enterprise;

Forecast amendment. The year-by-year forecast data of the operating earnings, net profit, and earnings per share of the target enterprise are periodically acquired, and present values and previous values are determined item by item to obtain amendment ranges by comparison.

The present disclosure provides a data processing and visualization apparatus, which includes:
an acquisition module, configured to select a data platform to acquire source data of a target enterprise; a sorting module, configured to sort the source data and load the source data into a data system to serve as a source database table; a first processing module, configured to execute a primary data operation to process the source data into target data; a second processing module, i.e. the determination module, configured to execute a secondary data operation to process the target data into value-added data; a third processing module, configured to execute a tertiary data operation to process relevant data into graphic data; and a visualization module, configured to execute data visualization to draw and render a visual graph according to the graphical data.

The technical solutions provided by various embodiments of the present disclosure are described in detail below in conjunction with the accompanying drawings.

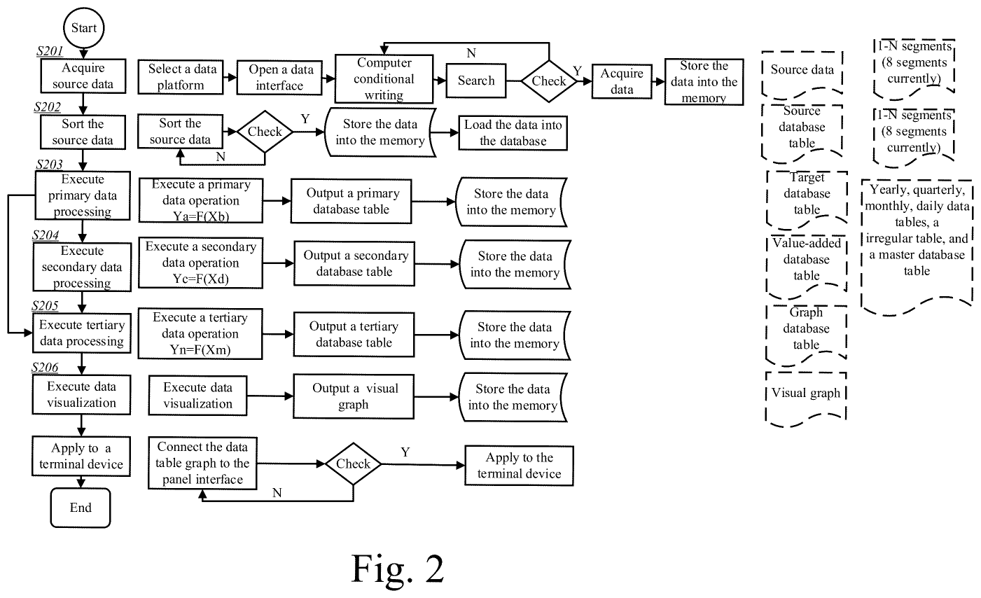

FIG. 2 is a schematic diagram of an embodiment of a data processing and visualization method provided in the present disclosure, the method including:

At S201, source data is acquired.

A data platform may be selected to acquire source data of a target enterprise.

A terminal device may select different data platforms for regular comparison to reduce platform acquisition restrictions, acquire source data from a selected data platform using a computer-written condition, and make up for the missing acquisition caused by the change in background data accounting at a certain time through the acquisition of data at different time points, to divide the specific acquisition into 1−N segments by means of a segmentation method according to relevant data attributes and scroll refresh time.

In the actual data acquisition process, the data platforms have restrictions on the amount of data acquired each time. For example, one of the platforms is set to have 80 search conditions, 120 columns of header indicators and 500 words in question sentences, while the amount of data required to be acquired by the present disclosure exceeds these setting conditions. The refresh of indicator data by the data platforms are not all completed at the same time point, which is related to the data attributes. For example, the operating earnings data of all target enterprises can be acquired at 3 pm, but the scroll net profit data cannot be fully acquired. To solve this problem, in this embodiment, the source data is captured in 8 segments, and captured respectively at 3 pm every day and 8 am the next day, so as to ensure the timeliness and completeness of data acquisition.

The source data of the target enterprise may be enterprise's daily report form, monthly report form, quarterly report form, annual report form, and various data involved in each report form. In the present disclosure, the terminal device may also set a plurality of time points for acquiring data to acquire the source data of the target enterprise corresponding to each time point.

After the terminal device acquires the source data corresponding to the plurality of time points, because the data to be processed acquired at the latest time point is the most accurate data, the terminal device may first determine missing data of the data to be processed acquired at the latest time point, then search for the missing data from the source data acquired at other time points and fill the missing data into the source data acquired at the latest time point; and store the source data in a preset data system as source data to be processed.

In practical applications, the source data may be divided into associated data and unassociated data, where the associated data can only be acquired after other data are determined. For example, if enterprise A does not acquire the non-recurring gains and losses data today, the data of net profit after deducting non-recurring gains and losses cannot be determined.

For associated data, if the associated data in the source data is acquired as a whole, the missing of some associated data may lead to the missing of other associated data, resulting in a situation where less data is acquired. Therefore, in the present disclosure, the terminal device may acquire the format of a report form of the target enterprise, to determine various data belonging to the associated data in the report form according to the format of the report form, and respectively capture various associated data to acquire various source data.

At S202, the source data is sorted.

The source data is sorted and loaded into a preset data system to serve as a source database table. The terminal device may sort the acquired source data to be processed according to data attributes and data scripts, and then load the acquired source data to be processed into the data system to serve as a source database table. In this embodiment, data fields, data scripts and data sequences are sorted. Before loading the acquired source data to be processed into the data system, redundant data is removed and it is ensured that the data format is consistent with the design of the data system.

At S203, primary data processing is executed.

The terminal device may execute a primary data operation to process the source data into target data. A primary data operation Ya=f(Xb) is executed and a primary database table is output. In this embodiment, the terminal device converts the source data into a daily table, a quarterly table, a yearly table, an irregular table and a master database table according to the definition fields and time scripts representing the data attributes.

At S204, secondary data processing is executed.

The terminal device may execute a secondary data operation to process the target data into value-added data.

A secondary data operation Yc=f(Xd) is executed and a secondary database table is output. The terminal device may use relevant data to create an integrated multi-dimensional data model and algorithm, and conduct an integration analysis on the target enterprise.

An embodiment of a data model and algorithm provided in the present disclosure is described as follows, including the following methods.

New indicators are established, mainly including:
growth price-to-earnings times GPET, which is a dynamic indicator, may be used as a single-segment value indicator or as a segmented composite integrated value indicator, and determined by a net profit growth rate and a dynamic price-to-earnings ratio after deducting non-recurring gains and losses; and
dynamic price-to-earnings ratio after deducting non-recurring gains and losses PEAN, which is a dynamic indicator, determined by the market value and the annualized recurring profit, and also represents the capacity indicator of the target enterprise when determining the value space in the data model.

Comprehensive capacity is determined, including four basic dimensions of value capacity, growth capacity, revenue growth and profit growth, and a comparative dimension. Scoring criteria is set for reviewing the comprehensive capacity on an annual basis using a scoring method of segment comparison, which is achieved specifically through expert seminars.

Specifically, the comprehensive capacity indicator is represented by CAP, and the segment scoring criteria may be referred to the table as follows:

| | Scores | | | | | |
|---|---|---|---|---|---|---|
| | 0 | 1 | 2 | 3 | 4 | 5 |
| | Scoring segments | | | | | |
| | (−∞, R0) | (R0, R1) | (R1, R2) | (R2, R3) | (R3, R4) | (R4, R5) |
| | Scoring dimensions | | | | | |
| | R0 | R1 | R2 | R3 | R4 | R5 |
| Upper limit of value capacity | 0 | 30% | 50% | 100% | 200% | ∞ |
| Lower limit of value capacity | 0 | 30% | 50% | 100% | 200% | ∞ |
| Growth capacity | 0 | 30% | 50% | 100% | 300% | ∞ |
| Revenue growth | 0 | 30% | 50% | 100% | 500% | ∞ |
| Profit growth | 0 | 50% | 100% | 300% | 1000% | ∞ |

Value capacity is determined by taking the smaller one of scores for an upper limit and a lower limit of a value space determination result as a score of the value capacity. A fitting range corresponding to the value capacity is determined, including an upper limit and a lower limit of the value capacity determination result.

Specifically, the value capacity indicator is represented by VC, and the formula may be referred to:

$$SVC = min ( {SVS}_{max} , {SVS}_{min} )$$

$${VC}_{max} = PC \times ( 1 + {VS}_{max} )$$

$${VC}_{min} = PC \times ( 1 + {VS}_{min} )$$

where SVC may be the score of the value capacity, SVSₘₐₓ may be the score corresponding to the upper limit of the value space determination result, and SVSₘᵢₙ may be the score corresponding to the lower limit of the value space determination result; VCₘₐₓ and V_{Cmin} may be the upper limit and the lower limit of the fitting value capacity determination result and also represent the fitting range corresponding to the value capacity, and PC may be the current price.

Value space is determined by comparing the forecasted net profit growth rate with the dynamic price-to-earnings ratio after deducting non-recurring gains and losses. Specifically, corresponding values are determined by using the compound growth rate of the next two full years and the segmented growth rate respectively, then the corresponding values are determined in conjunction with the moving benchmarks including the current quarter, the current year, the forecast quarter and the future year respectively, and finally, values are taken in conjunction with the method for interactive comparison, and preferentially data with a lower determined value are taken as a constraint condition in the value-taking process. Forecast data of enterprises that have issued performance forecasts are also determined. Moreover, the goodwill-to-assets ratio is approximately taken as a risk factor for the realization of enterprise value, and then a relevant determination is taken as an amendment factor for the value space of the enterprise.

Specifically, the formula may be referred to:

$${VS}_{max} = ( {V}_{max} - 1 ) \times AF / 100$$

$${VS}_{min} = ( {V}_{min} - 1 ) \times AF / 100$$

$${V}_{max} = min \{ max ( \frac{{g}_{1}}{{p}_{1}} , \frac{{g}_{3}}{{p}_{1}} , \frac{{g}_{1}}{{p}_{2}} , \frac{{g}_{3}}{{p}_{2}} ) , min ( \frac{{g}_{2}}{{p}_{3}} , \frac{{g}_{3}}{{p}_{3}} ) \}$$

$${V}_{min} = min ( \frac{{g}_{1}}{{p}_{1}} , \frac{{g}_{3}}{{p}_{1}} , \frac{{g}_{1}}{{p}_{2}} , \frac{{g}_{3}}{{p}_{2}} , \frac{{g}_{2}}{{p}_{3}} , \frac{{g}_{3}}{{p}_{3}} , \frac{{g}_{1}}{{p}_{4}} , \frac{{g}_{3}}{{p}_{4}} , )$$

$$AF = 1 - \frac{GW}{TA}$$

$$p = \frac{MV}{NPAN}$$

$$v = \frac{g}{p}$$

where VSₘₐₓ and VSₘᵢₙ may be an upper limit and a lower limit of the value space, and Vₘₐₓ and Vₘᵢₙ may be an upper limit and a lower limit of a value indicator determination result; AF may be a value amendment factor, GW may be goodwill, and TA may be total assets; v may be the value indicator, or may also be called the growth price-to-earnings times or represented by GPET; p may be the dynamic price-to-earnings ratio after deducting non-recurring gains and losses PEAN, referred to as the PER after deducting non-recurring gains and losses or PE after deducting non-recurring gains and losses, and also represents the capacity indicator of the target enterprise described in the data model; MV may be the market value of the enterprise, and NPAN may be the net profit after deducting recurring gains and losses; and g may be the forecasted net profit growth rate.

Specifically, the determination incidence matrix may be referred to:

| Value indicator determination incidence matrix | | | | Forecast of | Forecast of | Forecast of the |
|---|---|---|---|---|---|---|
| | | | Serial number | the net profit | the net profit | compound growth |
| | | | of PER after | growth rate | growth rate | rate of net profit |
| | | Serial | deducting | for the next | for the year | for the next two |
| | | number of | non-recurring | year | after next | years |
| Grouping | | value | gains and | Growth 1 | Growth 2 | Growth 3 |
| time | Indicators | Indicators v | losses p | g1 | g2 | g3 |
| Group 1 | Value | v1 | Capacity 1 | g1/p1 | | |
| Current | indicator | | p1 | | | |
| quarter | Composite | v2 | | | | g3/p1 |
| | value | | | | | |
| | indicator | | | | | |
| Group 2 | Value | v3 | Capacity 2 | g1/p2 | | |
| Current | indicator | | p2 | | | |
| year | Composite | v4 | | | | g3/p2 |
| | value | | | | | |
| | indicator | | | | | |
| Group 3 | Value | v5 | Capacity 3 | | g2/p3 | |
| Next | indicator | | p3 | | | |
| year | Composite | v6 | | | | g3/p3 |
| | value | | | | | |
| | indicator | | | | | |
| Group 4 | Value | v7 | Capacity 4 | g1/p4 | | |
| Forecast | indicator | | p4 | | | |
| quarter | Composite | v8 | | | | g3/p4 |
| | value | | | | | |
| | indicator | | | | | |

Target space is determined. The comprehensive target price of a master data table in the target data is captured to determine a more intuitive target space of the current price relative to the comprehensive target price, which is represented by the percentage of the determination result.

Specifically, the formula may be referred to:

$$TS = CTP / PC - 1$$

where TS may be the target space, CTP may be the comprehensive target price, and PC may be the present price, i.e., the current price.

Growth capacity is determined. The forecasted earnings per share growth rate is used to derive a growth rate forecast to represent future growth capacity, and a growth forecast amendment is used to dynamically track the adjustment trend of the growth forecast of the target enterprise.

Specifically, the formula may be referred to:

$$GRF = avg ( {EPS}_{y + 1} , {EPS}_{y + 2} )$$

where GRF may be the growth rate forecast, EPS_{y+1} and EPS_{y+2} may be the forecasted earnings per share growth rates for the next year and the year after next respectively.

Forecast amendment is determined. The year-by-year forecast data of the operating earnings, net profit, and earnings per share of the target enterprise are periodically acquired, and present values and previous values are determined item by item to obtain amendment ranges by comparison.

Specifically, the formula may be referred to:

$$FEA = \frac{CEV}{BEV} - 1$$

$$FPA = \frac{CPV}{BPV} - 1$$

$$FEPSA = \frac{CEPSV}{BEPSV} - 1$$

where FEA, FPA and FEPSA may be the forecasted amendment ranges of the operating earnings, net profit and earnings per share respectively, CEV, CPV, CEPSV may be the forecasted present values of the operating earnings, net profit and earnings per share respectively, and BEV, BPV and BEPSV may be the forecasted previous values of the operating earnings, net profit and earnings per share respectively.

According to the above formula, the terminal device may determine the value capacity range and value capacity score, determine the value space, target space, growth capacity and forecast amendment, and determine the comprehensive capacity analysis of the target enterprise accordingly.

In order to make the description of the data model and algorithm above clearer, the main indicators involved are summarized as follows:

Newly established indicators

| Indicator code | Indicator name | Indicator definition | Formula or explanation |
|---|---|---|---|
| GPET | Growth price- | The times of forecasted | GPET = forecasted net profit growth |
| | to-earnings | net profit growth rate | rate/dynamic price-to-earnings ratio after |
| | times | relative to dynamic | deducting non-recurring gains and losses |
| | | price-to-earnings ratio | |
| | | after deducting non- | |
| | | recurring gains and | |
| | | losses | |
| PEAN | Dynamic price- | The ratio of current | PEAN = current market value/annualized |
| | to-earnings ratio | market value to net | net profit after deducting non-recurring |
| | after deducting | profit after deducting | gains and losses = |
| | non-recurring | non-recurring gains and | current market value/annualized |
| | gains and losses, | losses | recurring profit |
| | referred to as | | |
| | PE after | | |
| | deducting non- | | |
| | recurring gains | | |
| | and losses | | |
| CAP | Comprehensive | The comprehensive | Referring to the segment scoring criteria |
| | capacity | capacity of the target | |
| | | enterprise in four | |
| | | dimensions: value | |
| | | capacity, growth | |
| | | capacity, revenue growth | |
| | | and profit growth | |
| SVC | Score of value | Scores corresponding to | SVC = min(SVSₘₐₓ, SVSₘᵢₙ) |
| | capacity | the upper limit and | |
| | | lower limit of the value | |
| | | capacity determination result | |
| SVS | Score of value | Scores corresponding to | Referring to the segment scoring criteria |
| | space | the upper limit and | |
| | | lower limit of the value | |
| | | space determination | |
| | | result | |
| VC | Value capacity | The capacity of the | VCₘₐₓ = PC × (1 + VSₘₐₓ) |
| | | target enterprise to | VCₘᵢₙ = PC × (1 + VSₘᵢₙ) |
| | | achieve a fluctuation | |
| | | target in terms of | |
| | | achieving value growth | |
| VS | Value space | The value fluctuation | VSₘₐₓ = (Vₘₐₓ − 1) × AF/100 |
| | | space range of the target | VSₘᵢₙ = (Vₘᵢₙ − 1) × AF/100 |
| | | enterprise based on its | |
| | | operating condition and | |
| | | market performance | |
| AF | Value amendment factor | The amendment factor after deducting the value realization risk mainly caused by goodwill | $AF = 1 - \frac{GW}{TA}$ |
| V | Integrated value indicator | The code in a determination, the upper limit or lower limit of the integrated determination result based on the segmented recombination, equivalent to the integrated GPET | ${V}_{max} = min \{ max ( \frac{{g}_{1}}{{p}_{1}} , \frac{{g}_{3}}{{p}_{1}} , \frac{{g}_{1}}{{p}_{2}} , \frac{{g}_{3}}{{p}_{2}} ) , min ( \frac{{g}_{2}}{{p}_{3}} , \frac{{g}_{3}}{{p}_{3}} ) \}$ ${V}_{min} = min ( \frac{{g}_{1}}{{p}_{1}} , \frac{{g}_{3}}{{p}_{1}} , \frac{{g}_{1}}{{p}_{2}} , \frac{{g}_{3}}{{p}_{2}} , \frac{{g}_{2}}{{p}_{3}} , \frac{{g}_{3}}{{p}_{3}} , \frac{{g}_{1}}{{p}_{4}} , \frac{{g}_{3}}{{p}_{4}} , )$ |
| V | Value indicator | The code in a determination, equivalent to the GPET determined in each segment | $v = \frac{g}{p}$ |
| TS | Target space | The target fluctuation | TS = CTP/PC − 1 |
| | | space of the target | |
| | | enterprise based on its | |
| | | operating condition and | |
| | | market performance | |
| GRF | Growth rate | The average of the | GRF = avg(EPS_{y+1}, EPS_{y+2}) |
| | forecast | forecasted earnings per | |
| | | share growth rates for | |
| | | the next two years | |
| FEA | Forecasted operating earnings amendment | The range of change in the current value of the forecasted operating earnings compared to the | $FEA = \frac{CEV}{BEV} - 1$ |
| | range | previous value | |
| FPA | Forecasted net profit amendment | The range of change in the current value of the forecasted net profit | $FPA = \frac{CPV}{BPV} - 1$ |
| | range | compared to the | |
| | | previous value | |
| FEPSA | Forecasted earnings per share | The range of change in the current value of the forecasted earnings per | $FEPSA = \frac{CEPSV}{BEPSV} - 1$ |
| | amendment | share compared to the | |
| | range | previous value | |

Conventional indicators

| Indicator | | | Formula or |
|---|---|---|---|
| code | Indicator name | Indicator definition | explanation |
| PC | Present price | The closing price of | Omitted |
| | | the latest day | |
| GW | Goodwill | Mainly the | Omitted |
| | | difference between | |
| | | the fair market value | |
| | | of the net assets of | |
| | | the acquired | |
| | | enterprise on the | |
| | | acquisition date and | |
| | | its book value | |
| TA | Total assets | Total assets of the | Omitted |
| | | enterprise | |
| MV | Market value | The total value of | The market price per |
| | | the issued shares of | share of the listed |
| | | a listed company | company multiplied by |
| | | determined by | the total number of |
| | | market price | shares issued |
| NPAN | Net profit after | Net profit after | Net profit subtracted |
| | deducting non- | deducting non- | by non-recurring gains |
| | recurring gains | recurring gains | and losses attributable |
| | and losses | and losses | to the owner of the |
| | | | parent company |
| CTP | Comprehensive | The target price | Omitted |
| | target price | obtained | |
| | | comprehensively | |
| EPS | Earnings per | The ratio of after- | EPSy₊1 and EPS_{y+2} |
| | share | tax profit to total | are the forecasted |
| | | share capital | earnings per share |
| | | | growth rates for the |
| | | | next year and the year |
| | | | after next respectively. |
| CEV | Present value | Current value of | Omitted |
| | of forecasted | forecasted operating | |
| | operating | earnings | |
| | earnings | | |
| CPV | Present value | Current value of | Omitted |
| | of forecasted | forecasted net profit | |
| | net profit | | |
| CEPSV | Present value | Current value of | Omitted |
| | of forecasted | forecasted earnings | |
| | earnings per | per share | |
| | share | | |
| BEV | Former value | Previous value of | Take the value at the |
| | of forecasted | forecasted operating | end of the previous |
| | operating | earnings | month |
| | earnings | | |
| BPV | Former value | Previous value of | Take the value at the |
| | of forecasted | forecasted net profit | end of the previous |
| | net profit | | month |
| BEPSV | Former value | Previous value of | Take the value at the |
| | of forecasted | forecasted earnings | end of the previous |
| | earnings per | per share | month |
| | share | | |

At S205, tertiary data processing is executed.

The terminal device may execute a tertiary data operation to process relevant data into graphic data.

Executing a tertiary data operations Ym=f(Xn) mainly includes: processing the relevant primary data and secondary data into graph database tables, in this embodiment, selecting industry and concept data in a master data table of a primary database table, then selecting data related to comprehensive capacity, value capacity, growth capacity, revenue growth and profit growth in a secondary database table, and processing these data into corresponding graph database tables.

At S206, data visualization is executed.

The terminal device may execute data visualization, to draw and display a visual graph according to the graphic data, which includes:
selecting graphic data, and coupling background data and a front-end display of a panel interface using visualization tool software in conjunction with self-compiled programs for completing automation tasks; drawing and rendering a corresponding visual graph according to a background data relationship in the data model and algorithm as described, where industry maps and concept maps respectively use methods of subordinate and association grading, color rendering, and representing categories and hierarchical relationships using colors.

In this embodiment, the first grade of industry map, the second grade of industry map, the third grade of industry map, the first grade of concept map, the second grade of concept map, the third grade of concept map, the comprehensive capacity map, the value capacity map, the growth capacity map, the revenue growth map, the profit growth map and the enterprise N-dimensional map as well as the panel interface map are output respectively, and the relationships among these maps are displayed by means of human-computer interaction, buttons, colors and annotations through the operation design of the terminal panel interface, thereby optimizing the user experience, improving the effectiveness of data display, and improving the availability of a data system.

An embodiment of an industry map grading and visualization flow provided in the present disclosure will be described below.

The industry maps are divided according to an industry to which the target enterprise belongs, and are divided into three grades according to the subordinate relationships, where the first grade includes the second grade, and the second grade includes the third grade. Grid graphs are drawn and rendered according to the industry data of each grade by the terminal device, and different industries and different grades of the same industry are distinguished using colors. Each cell in these graphs displays the industry name and the number of enterprises included, and the terminal device may search for the target enterprise from the target data linked to these cells, so industry information may also be displayed on the panel interface of the target enterprise.

An embodiment of a conceptual map grading and visualization flow provided in the present disclosure will be described below.

The concept maps are divided according to a concept to which the target enterprise belongs, and are divided into three grades according to the association relationships but not necessarily the subordinate relationships. Grid graphs are drawn and rendered according to the concept data of each grade by the terminal device, and different concepts and different grades of the same concept are distinguished using colors. Each cell in these graphs displays the concept name and the number of enterprises included, and the terminal device may search for the target enterprise from the target data linked to these cells, so concept information may also be displayed on the panel interface of the target enterprise.

An embodiment of a comprehensive capacity map provided in the present disclosure will be described below.

The comprehensive capacity map is in the form of a radar graph, which is expressed as a value radar graph. The outer curve represents the standard score in the industry to which the target enterprise belongs, which is determined by the terminal device based on the acquired graphic data, and the inner curve represents the enterprise score of the target enterprise. The terminal device may give a score to the target enterprise in four dimensions: value capacity, growth capacity, revenue growth and profit growth.

An embodiment of a value capacity map provided in the present disclosure will be described below.

The value capacity map adopts the determination of the value space and is expressed as a value space graph. The terminal device may determine corresponding graphic data as a fitting curve of the value capacity range of the target enterprise, to intuitively and clearly express the upgradeable capacity space of the enterprise value in conjunction with the display of the existing comprehensive target price and the current price, i.e., the present price. Here, in order to display more distinctively, V_{MAX} and V_{MIN} are used to represent the upper limit VCₘₐₓ and the lower limit VCₘᵢₙ of the value capacity determination range described in the embodiment of the data model and algorithm. Meanwhile, the terminal device may also draw a comprehensive target line according to the acquired comprehensive target price data and the corresponding amendment data.

An embodiment of a growth capacity map provided in the present disclosure will be described below.

The growth capacity map adopts the determination of the growth forecast and is expressed as a growth forecast graph. The terminal device may draw curves of the current value and the previous value of the growth forecast according to the corresponding graphic data, so as to express the possible trend related to the future growth that the target enterprise can achieve.

An embodiment of a revenue growth map provided in the present disclosure will be described below.

The revenue growth curves and bar charts are drawn by the terminal device according to the acquired graphic data, which intuitively show the achievement of the forecast target of the target enterprise in terms of revenue, and also include the allocation and accumulation of the forecast target, the accumulation of actual revenue, and the amendment of the forecast target. Moreover, the year-on-year and month-on-month data change trends may also be observed according to the graph.

An embodiment of a profit growth map provided in the present disclosure will be described below.

The profit growth curves and bar charts are drawn by the terminal device according to the acquired graphic data, which intuitively show the achievement of the forecast target of the target enterprise in terms of profit, and also include the allocation and accumulation of the forecast target, the accumulation of actual profits, and the amendment of the forecast target. Moreover, the year-on-year and month-on-month data change trends may be observed according to the graph.

An embodiment of an enterprise N-dimensional map provided in the present disclosure will be described below.

The terminal device may automatically combine the visual graphs of the five dimensions for display, to intensively express the current status, trends and expected changing factors in various dimensions of the comprehensive capacity, value capacity, growth capacity, revenue growth and profit growth of the enterprise. An integrated graph may be used to represent an overall outline of the operating condition and market performance of the target enterprise.

An embodiment of a panel interface map provided in the present disclosure will be described below.

The terminal device may produce an intuitive, clear and easy-to-operate panel interface, which may be used as a window for a data system. The terminal device may also combine different graphs respectively on the panel interface for display by operating the buttons in the middle. Moreover, the right part of the panel interface displays the graded rendering colors associated with the industry maps and concept maps. In particular, the concept map column may be displayed in a scrolling manner by sliding the mouse. In addition, the panel interface also displays the target data in an association manner.

The background data relationship of the above data visualization is based on the data model and algorithm as described.

It can be seen from the above method that the terminal device may select different data platforms and ensure timely and complete acquisition of source data by acquiring data at different time points and acquiring data in segments; sort the acquired source data according to data attributes and data scripts to ensure that the source data is available; and create an integrated multi-dimensional data model and algorithm, establish new indicators to strengthen the rigor of a data model definition, especially the determination by comparing the forecasted net profit growth rate with the dynamic price-to-earnings ratio after deducting non-recurring gains and losses. Deducting non-recurring gains and losses reduces the impact of factors other than the normal operation of the enterprise on analysis, the segment determination in conjunction with moving benchmark and the use of the method for interactive comparison of values reduce determination deviations. The added forecast data determination improves timeliness, and the value amendment factor determination reduces risks, such that the data model and algorithm of the present disclosure can systematically improve the accuracy of analysis of the comprehensive capacity of the enterprise. Background data and a front-end display of a panel interface may be coupled using visualization tool software in conjunction with self-compiled programs for completing automation tasks, thereby improving the effectiveness of data display, and also improving the availability of a data system.

The above is a data processing method provided by one or more embodiments of the present disclosure.

The present disclosure provides a data processing and visualization medium, that is, a computer-readable storage medium storing a computer program which, when executed by a processor, causes the processor to implement the method described in the process of the above-mentioned FIG. 1 or FIG. 2.

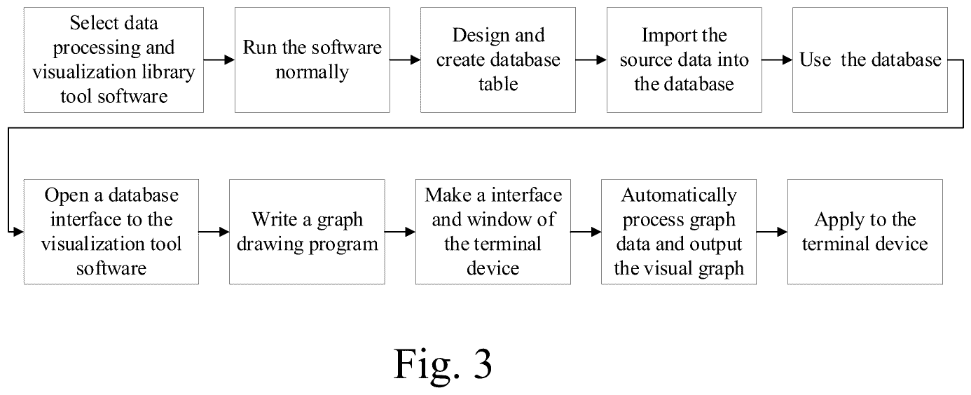

As shown in FIG. 3, when selecting tool software for data processing, database software may be selected. For the database table design and creation, SQL statements, automated programming languages and controls may be used to compile corresponding a computer program. Then data visualization tool software may be selected, to open a database table interface from the database software to the data visualization software, use automated programming languages and controls to compile a graph drawing program, design and make a panel interface, and perform the operation and use of the data system through software implementation.

The artificial intelligence technology of machine learning and model training may be used on the basis of a map data model including map data word frequency counting, grade number rules, serial number merging, color value reading and color rendering, to ensure that the computer program may automatically render a corresponding map pattern and keep the same automatically updated, and achieve non-repetition of thousands of colors representing industry concept attributes. Moreover, the artificial intelligence technology of machine learning and model training may also be used for the output of valuable data based on the data model and algorithm, to provide more professional data sets in simulation, forecast, analysis, and other applications.

The present disclosure provides a data processing and visualization device, that is, an electronic device, including a memory, a processor, and a computer program stored in the memory and executable on the processor, where the processor implements the method described in the process of the above-mentioned FIG. 1 or FIG. 2 when executing the program.

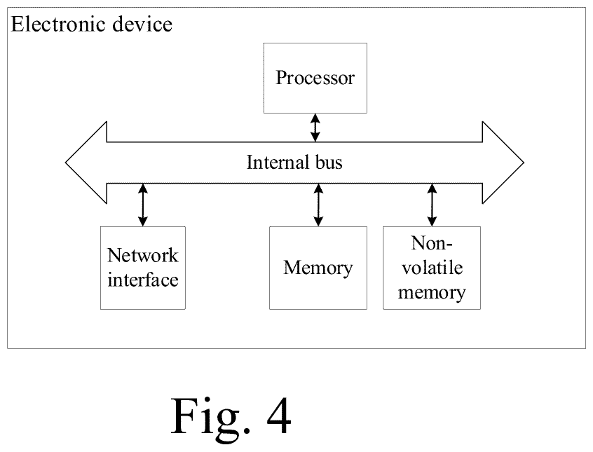

FIG. 4 is a schematic structural diagram showing an electronic device corresponding to FIG. 1. At the hardware level, the electronic device includes a processor, an internal bus, a network interface, a memory, and a non-volatile memory, and of course, may further include hardware required for other services. The processor reads a corresponding computer program from the non-volatile memory into the memory and then runs same to implement the data processing method described in the above-mentioned FIG. 1. Of course, in addition to a software implementation, the present disclosure does not exclude other implementations, such as logic devices or a combination of software and hardware, etc., that is to say, the execution subject of the following processing flow is not limited to various logic unit, but may also be hardware or logic devices. Those having ordinary skill in the art should also be aware that it is easy to obtain a hardware circuit that implements the logical method flow as long as the method flow is logically programmed slightly using the above-mentioned hardware description languages and programmed into an integrated circuit.

The systems, apparatuses, modules or units described in the above embodiments may be specifically implemented by computer chips or entities, or by products with certain functions. Those having ordinary skill in the art should appreciate that the embodiments of the present disclosure may be provided as methods, systems, or computer program products. The present disclosure is described with reference to flowcharts and/or block diagrams of methods, devices (systems), and computer program products according to embodiments of the present disclosure. It should be understood that each flow and/or block in a flowchart and/or block diagram, and a combination of the flows and/or blocks in the flowchart and/or block diagram may be implemented by computer program instructions. These computer program instructions may be provided to a processor of a general-purpose computer, a special-purpose computer, an embedded processor or other programmable data processing device to produce a machine, such that the instructions executed by the processor of the computer or other programmable data processing device produce an apparatus for implementing the functions specified in one or more flows in the flowchart and/or one or more blocks in the block diagram.

These computer program instructions may also be stored in a computer-readable memory that can direct a computer or other programmable data processing device to operate in a specific manner, such that the instructions stored in the computer-readable memory produce a manufactured product including an instruction apparatus that implements the functions specified in one or more flows in the flowchart and/or one or more blocks in the block diagram. In a typical configuration, a computing device includes one or more central processing units (CPU), an input/output interface, a network interface and a memory.

Those having ordinary skill in the art should understand that the embodiments of the present disclosure may be provided as methods, systems or computer program products. Accordingly, the present disclosure may take the form of an all-hardware embodiment, an all-software embodiment, or an embodiment combining software and hardware. Furthermore, the present disclosure may take the form of a computer program product implemented in one or more computer-usable storage media containing computer-usable program code(s). The present disclosure may be described in the general context of computer-executable instructions, such as program modules, executed by a computer. Generally, the program modules include routines, programs, objects, components, data structures, etc. that perform particular tasks or implement particular abstract data types.

It should also be noted that the terms “comprises”, “includes” or any other variations thereof are intended to cover a non-exclusive inclusion, so that a process, method, article or device that includes a series of elements not only includes those elements, but also includes other elements not explicitly listed or elements that are inherent to such process, method, article or device. Without more constraints, an element defined by the phrase “comprising a . . . ” does not exclude the existence of other identical elements in the process, method, article or device that comprise the element.

The various embodiments in the present disclosure are described in a progressive manner, and the same or similar parts between the various embodiments can be referenced to each other. Each embodiment focuses on the differences from other embodiments. In particular, for the system embodiment, since it is basically similar to the method embodiment, the description is relatively simple, and the relevant parts can be referred to the partial description of the method embodiment.

The above description is merely an embodiment of the present disclosure and is not intended to limit the present disclosure. For those having ordinary skill in the art, various modifications and variations may be made to the present disclosure. Any modifications, equivalent substitutions, improvements, etc. made within the gist and principles of the present disclosure should be included in the scope of the claims of the present disclosure.

What is claimed is:

1. A data processing and visualization method, comprising:
acquiring source data of a target enterprise from a data platform, storing the source data in a preset data system, and sorting the source data stored in the preset data system as target data;
creating a data model and algorithm, forecasting a net profit growth rate of the target enterprise according to the target data, determining a corresponding net profit after deducting non-recurring gains and losses of the target enterprise as a recurring profit, determining a capacity indicator of the target enterprise according to the recurring profit, and determining a value space of the target enterprise according to the capacity indicator and the net profit growth rate, to determine a fitting range and a corresponding value score of value capacity of the target enterprise according to the value space, and then determine a score of each dimension of comprehensive capacity of the target enterprise; and
drawing and rendering a corresponding visual graph according to a background data relationship in the data model and algorithm in conjunction with the target data, the value space, the value capacity, the value score and the comprehensive capacity, specifically comprising:
selecting graphic data, and coupling background data and a front-end display of a panel interface using visualization tool software in conjunction with self-developed programs for completing automation tasks; and
drawing and rendering a corresponding visual graph according to a background data relationship in the data model and algorithm, wherein the visual graph comprises: an industry map, a concept map, a comprehensive capacity map, a value capacity map, a growth capacity map, a revenue growth map, a profit growth map, an enterprise N-dimensional map and a panel interface map;
wherein the target data platform comprises a plurality of different data platforms, and acquiring source data of the target enterprise from the data platform specifically comprises:
acquiring source data of the target enterprise corresponding to each of a plurality of preset time points from each of the data platforms, comprising: acquiring the source data by means of a segmentation method according to data attributes and scroll refresh time; and determining each data belonging to associated data in a report form according to a format of the report form, and acquiring the source data from the respective target data platform according to a computer-written segmentation acquisition condition to achieve respective acquisition of all associated data;
determining missing data of the source data acquired at the latest time point, to search for the missing data from the source data acquired at other time points and fill the missing data into the source data acquired at the latest time point, and storing the source data in a preset data system as source data to be processed;
sorting the source data to be processed as target data; and
wherein sorting the source data stored in the preset data system comprises:
executing a primary data operation to output the source data to a primary database table;
executing a secondary data operation and outputting a secondary database table, using relevant data to create an integrated multi-dimensional data model and algorithm, and conducting an integration analysis on the target enterprise; and
executing a tertiary data operation to process relevant data in the primary database table and the secondary database table into corresponding graph database tables; and
wherein drawing and rendering the corresponding visual graph comprises:
determining rendering colors of all industry maps and all concept maps according to subordinate relationships and association relationships between the industry maps and the concept maps, to represent categories and hierarchical relationships of the industry maps and the concept maps through the rendering colors,
wherein the industry maps are divided according to an industry to which the target enterprise belongs, and the industry maps are divided into at least three grades according to the subordinate relationships of the industry maps; the concept maps are divided according to a concept to which the target enterprise belongs, and the concept maps are divided into at least three grades according to the association relationships and/or the subordinate relationships of the concept maps; and
the graded rendering colors of the industry maps and the concept maps are displayed in an association manner through the panel interface, and the concept maps are displayed in a scrolling manner; and
automatically combining visual graphs corresponding to the target data, the value space, the value capacity, the value score and the comprehensive capacity together for display to obtain the enterprise N-dimensional map which is configured to represent an overall outline of operating condition and market performance of the target enterprise.

2. The method according to claim 1, wherein creating the data model and algorithm, to determine the fitting range and the corresponding value score of value capacity of the target enterprise according to the value space, and then determine the score of each dimension of comprehensive capacity of the target enterprise specifically comprises:
determining a value capacity indicator, a growth capacity indicator, a revenue growth indicator and a profit growth indicator corresponding to the target enterprise according to the target data,
wherein the value capacity indicator comprises the fitting range and the corresponding value score of value capacity of the target enterprise; and
determining the value score for characterizing the comprehensive capacity of the target enterprise through segment scoring and dimension comparison according to four basic dimensions comprising the value capacity indicator, the growth capacity indicator, the revenue growth indicator and the profit growth indicator.

3. The method according to claim 2, wherein determining the fitting range and the corresponding value score of value capacity of the target enterprise according to the value space specifically comprises:
determining the fitting range of the value capacity according to an upper limit and a lower limit of the value space, and comparing value scores of the upper limit and the lower limit of the value space and determining the corresponding value score of the value capacity as a smaller one of the value scores of the upper limit and the lower limit of the value space.

4. The method according to claim 3, wherein determining the value space of the target enterprise specifically comprises:
forecasting the net profit growth rate of the target enterprise according to the target data, the net profit growth rate comprising: a first net profit growth rate, a second net profit growth rate and a third net profit growth rate, wherein the first net profit growth rate is a net profit growth rate for the next first year, the second net profit growth rate is a net profit growth rate for the next second year, and the third net profit growth rate is an average net profit growth rate for the next two years; and
determining the capacity indicator of the target enterprise according to the recurring profit, the capacity indicator comprising: a first capacity indicator, a second capacity indicator, a third capacity indicator and a fourth capacity indicator, wherein the first capacity indicator is a ratio of a market value of the target enterprise to an annualized recurring profit involved in a quarterly report form of a current quarter, the second capacity indicator is a ratio of the market value to a recurring profit involved in an annual report form of a current year, the third capacity indicator is a ratio of the market value to a recurring profit of the target enterprise in the next year, and the fourth capacity indicator is a ratio of the market value to a forecasted annualized recurring profit involved in a next quarterly report form; and
wherein determining the value space of the target enterprise according to the capacity indicator and the net profit growth rate comprises:
determining a first group of value indicators according to the first net profit growth rate, the third net profit growth rate and the first capacity indicator;
determining a second group of value indicators according to the first net profit growth rate, the third net profit growth rate and the second capacity indicator;
determining a third group of value indicators according to the second net profit growth rate, the third net profit growth rate and the third capacity indicator;
determining a fourth group of value indicators according to the first net profit growth rate, the third net profit growth rate and the fourth capacity indicator;
determining the upper limit of the value space according to the first group of value indicators, the second group of value indicators, and the third group of value indicators; and
determining the lower limit of the value space according to the first group of value indicators, the second group of value indicators, the third group of value indicators and the fourth group of value indicators.

5. The method according to claim 4, wherein determining the value space of the target enterprise further comprises:
determining growth price-to-earnings times as a GPET indicator according to the net profit growth rate and a dynamic price-to-earnings ratio after deducting non-recurring gains and losses of the target enterprise, wherein the GPET indicator is a single-segment value indicator and/or a segmented composite integrated value indicator,
in response to the GPET indicator being the integrated value indicator, determining the GPET indicator by comparing a segmented and/or composite net profit growth rate with a moving dynamic price-to-earnings ratio after deducting non-recurring gains and losses in conjunction with a method for interactive comparison of values; and
determining the value space according to the GPET indicator.

6. The method according to claim 4, wherein after determining the value space of the target enterprise, the method further comprises:
acquiring goodwill data corresponding to a goodwill-to-assets ratio of the target enterprise from the data platform; and
amending the value space according to the goodwill data.

7. The method according to claim 2, wherein determining the score of each dimension of comprehensive capacity of the target enterprise further comprises:
determining a growth rate forecast indicator of the target enterprise according to a forecasted earnings per share growth rate contained in the target data, and re-determining the growth rate forecast indicator after the target data is updated, to determine a changing trend of growth of the target enterprise according to a changing trend of the growth rate forecast indicator, and determine a dimension score of a growth capacity of the comprehensive capacity of the target enterprise.

8. The method according to claim 2, wherein after determining the score of each dimension of comprehensive capacity of the target enterprise, the method further comprises:
re-acquiring the source data of the target enterprise at preset time intervals; and
determining a range of change between year-by-year forecast data of operating earnings, net profit and earnings per share of the target enterprise contained in the updated target data and year-by-year forecast data of operating earnings, net profit and earnings per share of the target enterprise contained in the unupdated target data using the latest acquired target data in response to a refresh operation on the target data, to determine an amendment range according to the range of change.

9. The method according to claim 2, wherein after determining the score of each dimension of comprehensive capacity of the target enterprise, the method further comprises:
determining a comprehensive target price of the target enterprise according to the target data, and determining a target space of the target enterprise according to the comprehensive target price and the current price, to maintain amendment coverage by regularly updating the comprehensive target price.

10. A data processing and visualization medium, wherein the data processing and visualization medium is a non-transitory computer-readable storage medium storing a computer program which, when executed by a processor, causes the processor to implement the method according to claim 1.

11. A data processing and visualization device, wherein the data processing and visualization device is an electronic device comprising a memory, a processor and a computer program stored in the memory and executable on the processor, wherein the processor, when executing the program, implements the method according to claim 1.
